(19) United States
(12) Patent Application Publication
(10) Pub. No.: US 2010/0165075 A1
(43) Pub. Date: Jul. 1, 2010

(54) METHOD FOR AUTOMATICALLY SHOOTING PANORAMIC IMAGE BY DIGITAL IMAGE PICKUP DEVICE

(75) Inventors: Hong Long Chou, Taipei (TW); Chia Chun Tseng, Hsinchu City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Altek Corporation, Hsinchu (TW)

(21) Appl. No.: 12/471,999

(22) Filed: May 26, 2009

(30) Foreign Application Priority Data
Dec. 31, 2008 (TW) 097151820

(51) Int. Cl. H04N 7/00

(52) U.S. Cl. 348/36; 348/E07.001

(57) ABSTRACT

A method for automatically shooting a panoramic image by a digital image pickup device is described. In the method, a pixel error value between a real-time image and an alignment image overlapped with each other is continuously compared and calculated. When the pixel error value is smaller than a preset threshold value, the digital image pickup device is automatically driven to shoot a second image to be stitched and blended with a previous image into a panoramic image. The shooting of the panoramic image is simplified by using automatic image capturing.

### CROSS-REFERENCE TO RELATED APPLICATIONS

This non-provisional application claims priority under 35 U.S.C. §119(a) on Patent Application No(s). 097151820 filed in Taiwan, R.O.C. on Dec. 31, 2008 the entire contents of which are hereby incorporated by reference.

### BACKGROUND OF THE INVENTION

1. Field of Invention

The present invention relates to a panoramic image pickup method, and more particularly to a method for controlling a digital image pickup device to automatically capture a panoramic image.

2. Related Art

A panoramic image presents a wide view to simulate a scene of about 160 degrees that can be perceived by human eyes. In comparison with a common size image which is merely an area cut out of a scene, the common size image is the area concentrated by human eyes, while the panoramic image enables the viewer to feel the atmosphere of the current environment. The panoramic image is obtained by stitching and blending a plurality of images with the same specification in the same scene, so that the joining area between the images to be joined is critical to the successful formation of a panoramic image.

Two conventional methods for shooting a panoramic image are provided as follows. One is that a user moves a digital camera manually (by hand or using a stand) to shoot multiple images, then inputs the shot images into a computer, and employs an image processing software to stitch and blend the images to obtain a panoramic image. This method is rather difficult for common users. Besides, more professional skills are needed for shooting, otherwise the difficulty in the subsequent image joining is increased or the shooting effect is poor. In addition, a complex image software needs to be run for image joining.

The other method is that an assistant registration image is displayed on a display screen of a digital camera so as to assist a user to produce a panoramic image. However, this method requires the users to overlap the registration image with the scene themselves, and thus the registration ability of the users will be challenged, such that a captured image may not be necessarily at an optimal registration location due to perceptive errors of the human eyes, and the resulted registration error may also affect the subsequent panoramic joining. Even if the user overlaps the registration image with the scene perfectly, the digital camera may still shake when the shutter button is pressed for shooting, and thus a registration error occurs at the moment of shooting, which leads to a failure of producing a panoramic image.

### SUMMARY OF THE INVENTION

Regarding the conventional method of employing an assistant alignment image, the users have to overlap a alignment image with a scene themselves. Therefore, a method for automatically shooting a panoramic image by a digital image pickup device is provided to avoid failures resulted from handshakes or perceptive errors of the human eyes when shooting a panoramic image.

According to the present invention, the method for automatically shooting a panoramic image by a digital image pickup device comprises: selecting an area from a first image shot by the digital image pickup device to be set as a alignment image, then obtaining a real-time image and overlapping the alignment image with the real-time image, and continuously comparing and calculating to see whether a pixel error value between the alignment image and the real-time image is smaller than a preset threshold value. If yes, the digital image pickup device is driven to obtain a second image. Stitching and blending the second image with the first image into a panoramic image.

The method for automatically shooting a panoramic image by a digital image pickup device provided in the present invention may simplify the shooting of a panoramic image, and adopt an automatic shooting mode such that the user does not need to press the shutter button manually, thereby avoiding unsuccessful panoramic image shooting due to handshakes.

### BRIEF DESCRIPTION OF THE DRAWINGS

The present invention will become more fully understood from the detailed description given herein below for illustration only, and thus are not limitative of the present invention, and wherein:

FIG. 1 is a flow chart of a method for automatically shooting a panoramic image by a digital image pickup device according to an embodiment of the present invention.

FIG. 2 is a schematic view of a first image according to an embodiment of the present invention.

FIG. 3 is a schematic view of overlapping a faded alignment image on a real-time image according to an embodiment of the present invention.

FIG. 4 is a schematic view of calculating a pixel error value between a alignment image and a real-time image according to an embodiment of the present invention.

FIG. 5 is a flow chart of selecting an area from a first image to be set as a alignment image according to an embodiment of the present invention.

FIG. 6 is a schematic view of selecting an area from a first image to be set as a alignment image according to an embodiment of the present invention.

FIG. 7 is a flow chart of calculating a pixel error value between a alignment image and a real-time image according to an embodiment of the present invention.

FIG. 8 is a schematic view of stitching and blending a first image and a second image according to an embodiment of the present invention.

FIG. 9 is a schematic view of a panoramic image according to an embodiment of the present invention.

FIG. 10 is a schematic view of stitching and blending a panoramic image and a third image according to an embodiment of the present invention.

### DETAILED DESCRIPTION OF THE INVENTION

The method for automatically shooting a panoramic image by a digital image pickup device according to the present invention may be built in a storage device of an electronic device through a software or firmware program, and realized by a processor of the electronic device executing the built-in software or firmware program together with an image capturing function. Here, the electronic device may be a computer, a mobile phone, a personal digital assistant (PDA), or a digital image pickup device (camera), etc., with an image capturing function. In the following detailed description of the present invention, a digital image pickup device is taken as the most preferred embodiment of the present invention, and the accompanying drawings are for reference and illustration only, instead of limiting the invention to the aforementioned electronic device.

In this embodiment, a pixel error value between a real-time image and a alignment image overlapped on the real-time image is continuously compared and calculated to determine whether the digital image pickup device is driven to obtain a second image to be stitched and blended with a first image to obtain a panoramic image.

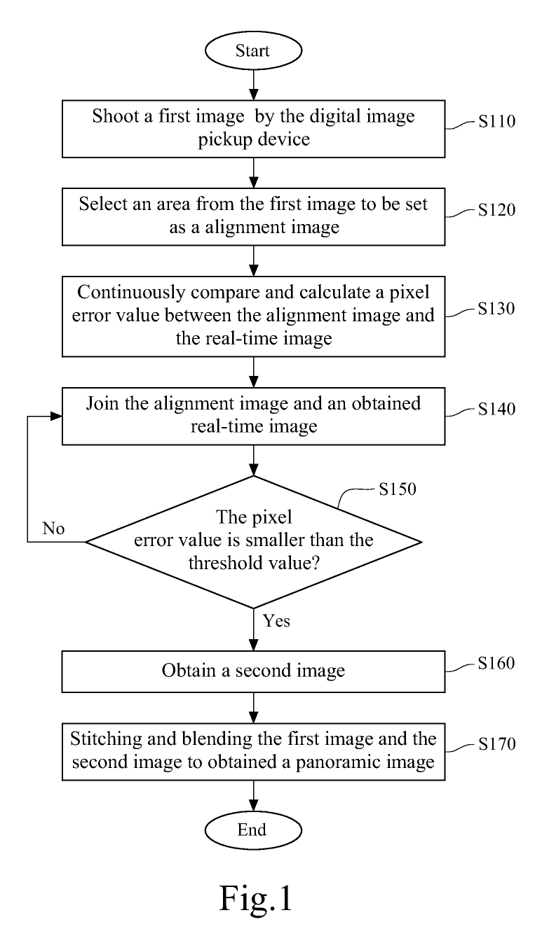

FIG. 1 is a flow chart of the method for automatically shooting a panoramic image by a digital image pickup device according to this embodiment. Referring to FIG. 1, the method comprises the following steps.

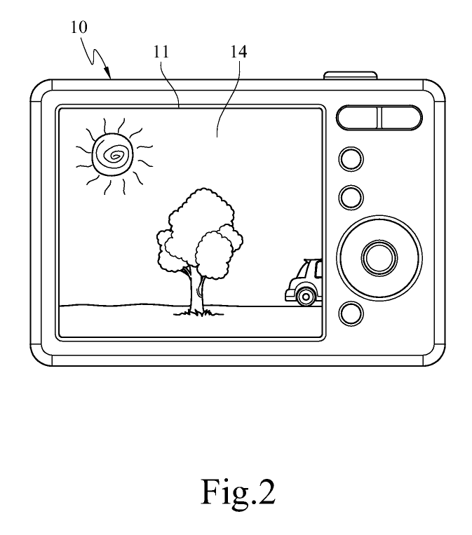

In Step S110, the digital image pickup device 10 shoots and stores a first image 14 (referring to FIG. 2).

In Step S120, an area of the first image 14 is selected to be set as a alignment image 15.

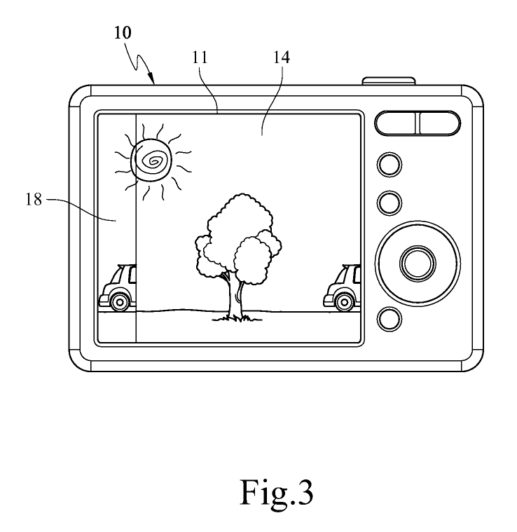

In Step S130, the digital image pickup device 10 fades the alignment image 15, obtains and displays a real-time image 16 on a display screen 11, and overlaps the faded alignment image 18 on the real-time image 16. The digital image pickup device 10 does not move at this point, so the scene of the real-time image 16 on the display screen 11 is the same as that of the first image 14 (referring to FIG. 3).

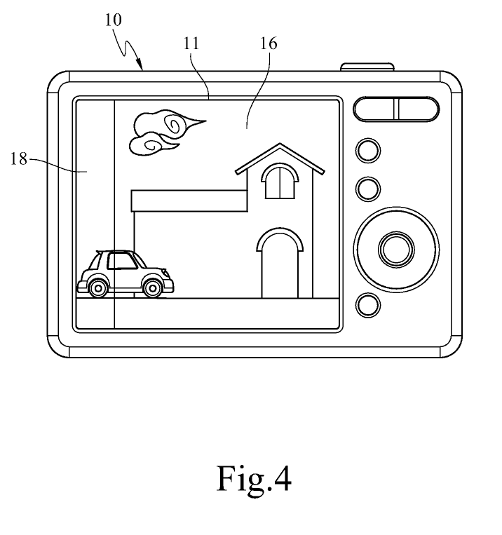

In Step S140, the digital image pickup device 10 starts to continuously compare the real-time image 16 with the overlapped alignment image 15 when rotating by itself, and calculate a pixel error value between the two images (see FIG. 4).

In Step S150, it is determined whether the pixel error value is smaller than a preset threshold value.

In Step S160, when the pixel error value is smaller than the threshold value, the digital image pickup device 10 immediately obtains a second image 17.

In Step S170, stitching and blending the first image 14 and the second image 17 are to obtained a panoramic image 13.

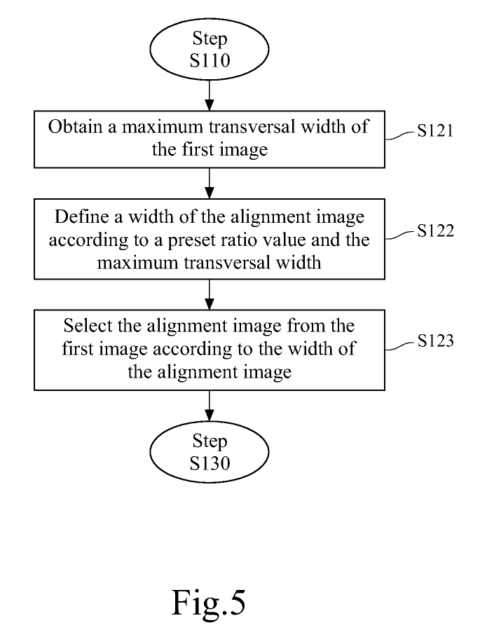

Referring to the steps shown in FIG. 5, a preferred method embodiment of Step S120 further comprises the following steps.

In Step S121, the digital image pickup device 10 obtains a maximum transversal width of the first image 14 when shooting the first image 14.

In Step S122, a width of the alignment image 15 is defined according to a ratio value preset in the digital image pickup device 10 and the maximum transversal width.

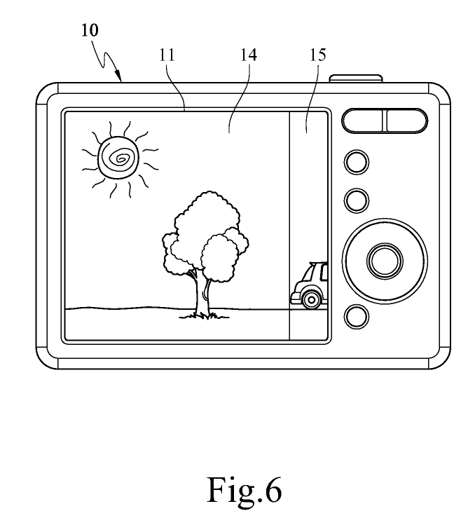

In Step S123, the alignment image 15 is selected from the first image 14 according to the width of the alignment image 15 (see FIG. 6).

As for the width of the alignment image described above, for example, the pixel size of the first image 14 is 800*600, the preset ratio value is 20%, and the selecting range of the alignment image 15 is calculated with the maximum transversal width value 800 of the first image 14 and the ratio value 20%, such that the transversal width of the alignment image 15 is 160, and it can be acquired that the pixel size of the alignment image 15 is 160*160.

The ratio value described above is set to avoid an excessively large alignment image 15 relative to the first image 14 when the user alters the size of the first image 14, such that the number of pixels that the digital image pickup device 10 needs to compare is prevented from becoming too great to affect the speed of calculation; or to avoid an excessively small alignment image 15 relative to the first image 14, such that an imprecise determination of the joining position is prevented from occurring. Therefore, the size of the alignment image 15 should be able to change with the size of the first image 14.

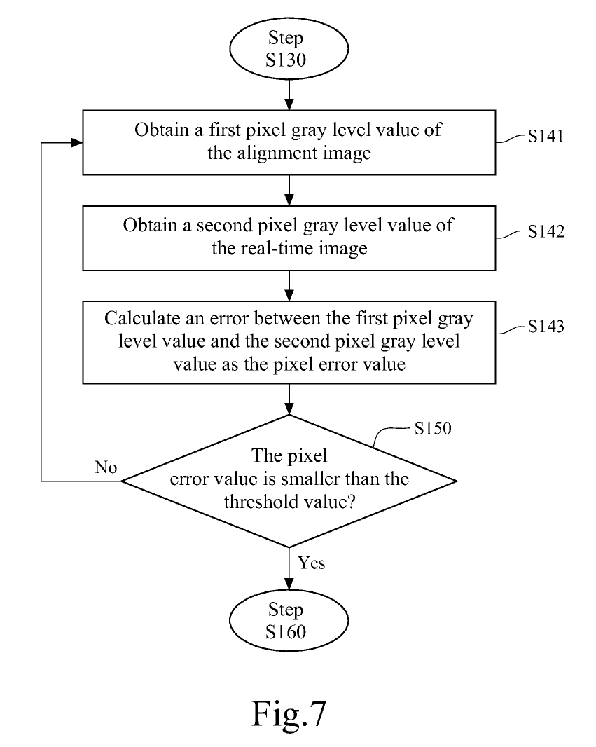

Referring to the steps shown in FIG. 7, a preferred method embodiment of Steps S140 to S150 further comprises the following steps.

In Step S141, a first pixel gray level value of the alignment image 15 is obtained.

In Step S142, a second pixel gray level value of the real-time image 16 is obtained.

In Step S143, an error between the first pixel gray level value and the second pixel gray level value is calculated as a pixel error value.

In Step S150, it is determined whether the error value is smaller than the preset threshold value, and if not, Steps S140 to S150 are repeated.

The present invention utilizes image subtraction to determine whether the overlapped images are the same based on the following principle. When moving, the digital image pickup device performs subtraction between the gray level values of the pixels at the same location of a previous frame and a frame before the previous frame, and the location with a large difference value represents a location with obvious alterations. The present invention utilizes this characteristic to perform subtraction between the real-time image and the alignment image overlapped on the real-time image to obtain an absolute value, and compare the absolute value with the preset threshold value to determine whether any alteration occurs at the overlapping position of the images. When the absolute value is smaller than the preset threshold value, it is determined that no alteration occurs, and when the absolute value is larger than the preset threshold value, it is determined that the pixel is a point with alteration. Finally, a ratio of the alteration range is calculated, and if the ratio exceeds a preset value, the images at the current overlapping position are different from each other.

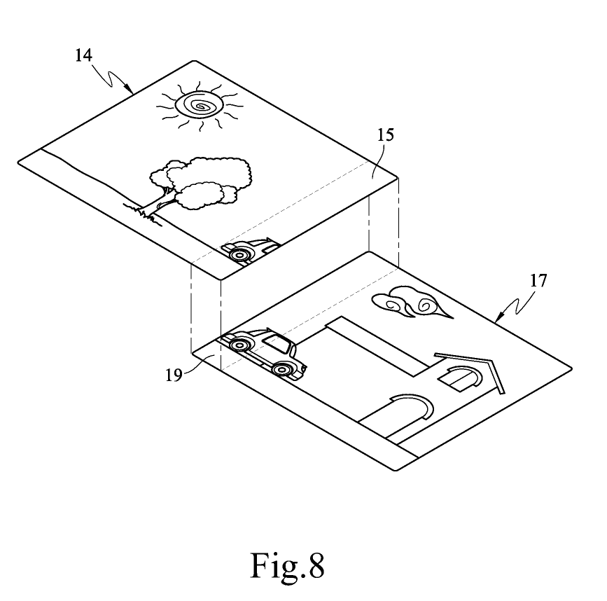

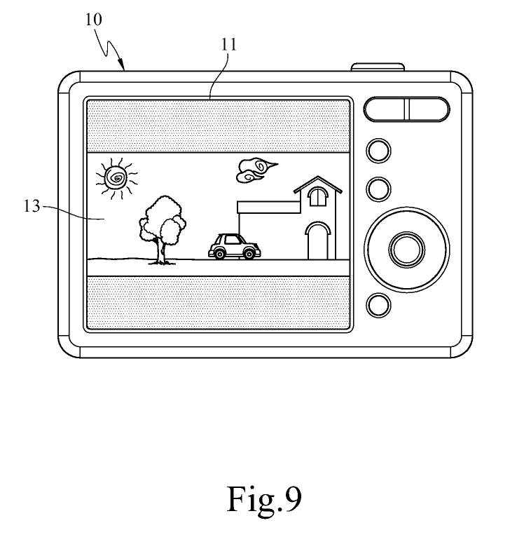

Referring to FIGS. 8 and 9, FIG. 8 is a schematic view of stitching and blending the first image and the second image according to this embodiment, and FIG. 9 is a schematic view of a panoramic image according to this embodiment.

In Step S160, when the pixel error value is smaller than the preset threshold value, the digital image pickup device 10 immediately shoots the real-time image 16 currently displayed by the display screen 11 as the second image 17.

In Step S170, a joining image 19 which is the same as the alignment image 15 is provided at one side of the shot second image 17, and the digital image pickup device 10 overlaps the alignment image 15 in the first image 14 with the joining image 19 in the second image 17, such that the first image 14 and the second image 17 are stitched and blended to obtain a panoramic image 13.

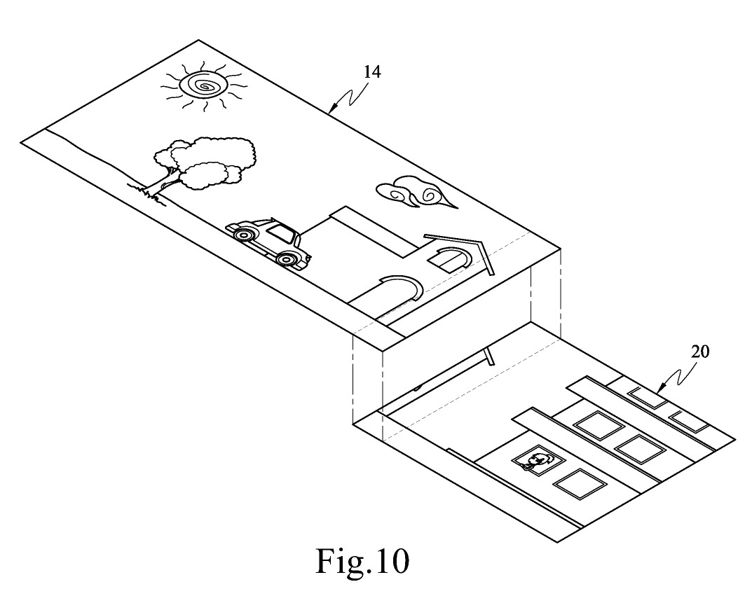

As shown in FIG. 10, it should be noted that, the present invention is not limited to the stitching and blending of two images. After stitching and blending the first image 14 and the second image 17, if the user intends to stitch and blend a third image 20 or stitch and blend a panoramic image with a viewing angle of 360 degrees, the user only has to repeatedly set the overlapped image as the first image 14, and perform Steps S120 to S170 to easily acquire a desired image.

Compared with the prior art, the method for automatically shooting a panoramic image by a digital image pickup device provided in the present invention may simplify the shooting of a panoramic image by the user, increase the alignment precision, and adopt an automatic shooting mode such that the user does not have to press the shutter button, thereby avoiding unsuccessful panoramic image shooting due to handshakes.

What is claimed is:

1. A method for automatically shooting a panoramic image by a digital image pickup device, applied to a digital image pickup device, the method comprising:
shooting a first image by the digital image pickup device;
selecting an area from the first image to be set as an alignment image;
obtaining a real-time image and overlapping the alignment image on the real-time image;
continuously comparing and calculating a pixel error value between the alignment image and the real-time image;
determining whether the pixel error value is smaller than a preset threshold value;
if yes, driving the digital image pickup device to shoot a second image; and
stitching and blending the first image and the second image to obtain a panoramic image.

2. The method for automatically shooting a panoramic image by a digital image pickup device according to claim 1, wherein the step of selecting an area from the first image to be set as the alignment image comprises:
obtaining a maximum transversal width of the first image;
defining a width of the alignment image according to a preset ratio value and the maximum transversal width; and
selecting the alignment image from the first image according to the width of the alignment image.

3. The method for automatically shooting a panoramic image by a digital image pickup device according to claim 1, wherein the step of continuously comparing and calculating a pixel error value between the alignment image and the real-time image comprises:
obtaining a first pixel gray level value of the alignment image;
obtaining a second pixel gray level value of the real-time image; and
calculating an error between the first pixel gray level value and the second pixel gray level value as the pixel error value.

4. The method for automatically shooting a panoramic image by a digital image pickup device according to claim 1, wherein the step of overlapping the alignment image on the real-time image further comprises fading the alignment image.
